(19) United States
(12) Patent Application Publication
(10) Pub. No.: US 2025/0108360 A1
(43) Pub. Date: Apr. 3, 2025

(54) SELECTIVE REVERSE WATER GAS SHIFT: GROUP 1A ALKALI METAL DOPING OF A METAL-CONTAINING PARTIALLY REDUCED METAL (IV) OXIDE

(71) Applicant: Southwest Research Institute, San Antonio, TX (US)

(72) Inventors: Grant S. SEUSER, Peoria, IL (US); Gary JACOBS, Helotes, TX (US)

(21) Appl. No.: 18/480,230

(22) Filed: Oct. 3, 2023

(51) Int. Cl. B01J 23/58; B01J 21/06; B01J 23/42; B01J 35/00; C01B 32/40

(52) U.S. Cl. CPC B01J 23/58; B01J 21/066; B01J 23/42; B01J 35/394; C01B 32/40

(57) ABSTRACT

A catalyst and method of reducing carbon dioxide to carbon monoxide via a reverse water gas shift reaction. The catalyst comprises Group 1A alkali metal doping of a metal-containing partially reduced metal (IV) oxide. Such catalyst selectively hydrogenates carbon dioxide to carbon monoxide at relatively low temperatures with a selectivity that reduces or avoids carbon dioxide conversion into hydrocarbons such as methane.

### FIELD

The present invention is directed at a catalyst and method of reducing carbon dioxide to carbon monoxide via a reverse water gas shift reaction. The catalyst comprises Group 1A alkali metal doping of a metal-containing partially reduced metal (IV) oxide. Such catalyst selectively hydrogenates carbon dioxide to carbon monoxide at relatively low temperatures with a selectivity that reduces or avoids carbon dioxide conversion into hydrocarbons such as methane.

### BACKGROUND

Synthesis gas is a composition of carbon monoxide and hydrogen that can be used to produce a variety of chemicals, such as fuels, waxes, methanol, and dimethyl ether. Traditional feedstocks for producing synthesis gas have come from coal, biomass, or natural gas, the first two being converted to syngas via a gasification process and the latter through partial oxidation and steam methane reforming processes (e.g., autothermal reforming).

Carbon dioxide (CO₂) can also be used as a feedstock for synthesis gas by reducing CO₂ to carbon monoxide (CO) to produce a syngas mixture. Regardless of the reducing agent used, CO₂ is a thermodynamically stable molecule that is quite resistant to the reduction to CO; therefore, almost all processes for CO₂ reductions are energy intensive. One method to produce synthesis gas from CO₂ is the reverse water gas shift (RWGS) reaction (Equation 1), in which CO₂ is reduced to CO with hydrogen gas (H₂) in the presence of a catalyst at temperatures of ≥600° C. Relatively high temperature is used to achieve sufficient conversion to CO. At the same time, the CO₂ methanation reaction (Equation 2) is preferably avoided, as it is a parasitic and highly exothermic side reaction that reduces syngas yield.

CO₂+H₂↔CO+H₂O (Equation 1)

CO₂+4 H₂→CH₄+2 H₂O (Equation 2)

Various transition metals dispersed on reducible oxide supports are reported to be active for CO₂ hydrogenation at relatively low temperature but are often mired by relatively low CO₂ conversion and the methanation side reaction. Ruthenium, cobalt, nickel, and rhodium metals are active towards CO₂ hydrogenation at relatively low temperature but are relatively highly selective towards methane formation. There have also been some reports regarding the selectivity of these catalyst types being tuned towards CO formation with dopants and through strong metal support interaction, but not without substantially diminishing CO₂ conversion. For example, copper is relatively active for the reverse water gas shift but suffers from relatively low activity at relatively low temperature. On the other hand, noble metals like platinum, palladium, and gold dispersed on reducible oxides like ceria, zirconia, and titania are all active catalysts at temperatures below 600° C. Platinum based catalysts on reducible oxides have been reported to have selectivity towards CO, but still have a degree of selectivity towards methane that increases with reactor pressure.

Therefore, it remains desirable to develop catalysts that are relatively active towards CO₂ hydrogenation, as well as selective in producing CO at relatively low temperature while reducing or avoiding the production of hydrocarbons such as methane.

### SUMMARY

A catalyst for performing a reverse water gas shift (RWGS) reaction comprising a partially reduced metal (IV) oxide active support of one or more of a ZrO₂, TiO₂, HfO₂, CeO₂, ThO₂ or MnO₂, containing a metal of one or more of a Pd, Pt, Ir, Cu, Ag or Au, wherein the catalyst is doped with a Group 1A alkali metal of one or more of a Na, Li, K, Rb or Cs.

A method for catalyzing a reverse water gas shift reaction comprising: (a) providing a catalyst comprising a partially reduced metal (IV) oxide active support of one or more of a ZrO₂, TiO₂, HfO₂, CeO₂, ThO₂ or MnO₂ that contains a metal of one or more of a Pd, Pt, Ir, Cu, Ag or Au, wherein the catalyst is doped with a Group 1A alkali metal of one or more of a Na, Li, K, Rb or Cs; (b) supplying the catalyst with a flow of carbon dioxide and hydrogen gas; (c) heating the catalyst to a temperature in the range of 200° C. to 500° C. and a pressure of 1 bar to 40 bar; and (d) recovering carbon monoxide.

### BRIEF DESCRIPTION OF THE DRAWINGS

FIG. 1 shows absorbance normalized to height versus wavenumbers for the RWGS reaction herein employing a sodium doped Pt/ZrO₂ catalyst where the n(CH) band of the observed formate groups move to relatively lower wavenumbers.

FIG. 2 shows absorbance (to scale) versus wavenumbers for the RWGS reaction herein employing a sodium doped Pt/ZrO₂ catalyst where the Pt-carbonyl n(CO) bands for the CO absorbed on the Pt move to lower intensities with increasing Na content.

FIG. 3 shows the absorbance versus wavenumbers for the 2.0% Pt/ZrO₂ control at the indicated temperatures as employed in the disclosed RWGS reaction.

FIG. 4 shows the absorbance versus wavenumbers for the 2.5% Na-2.0% Pt/ZrO₂ catalyst at the indicated temperatures as employed in the disclosed RWGS.

FIG. 5 shows CO₂ conversion and product selectivity under reverse water gas shift conditions under various H₂:CO₂ ratios for the 0% Na-2.0% Pt/ZrO₂ catalyst (undoped catalyst).

FIG. 6 shows CO₂ conversion and product selectivity under reverse water gas shift conditions under various H₂:CO₂ ratios for the 2.5% Na-2.0% Pt/ZrO₂ catalyst (doped catalyst).

FIG. 7 shows CO₂ conversion and product selectivity under reverse water gas shift conditions at various reactor pressures for the 0% Na-2.0% Pt/ZrO₂ catalyst (undoped catalyst).

FIG. 8 shows CO₂ conversion and product selectivity under reverse water gas shift conditions at various reactor pressures for the 2.5% Na-2.0% Pt/ZrO₂ catalyst (doped catalyst).

FIG. 9 shows the effect of temperature on CO₂ conversion and product selectivity under reverse water gas shift conditions for the 0% Na-2.0% Pt/ZrO₂ catalyst (undoped catalyst).

FIG. 10 shows the effect of temperature on CO₂ conversion and product selectivity under reverse water gas shift conditions for the 2.5% Na-2.0% Pt/ZrO₂ catalyst (doped catalyst).

### DETAILED DESCRIPTION

The present invention is directed at a catalyst and method of reducing carbon dioxide to carbon monoxide via a reverse water gas shift (RWGS) reaction. The catalyst comprises, consists essentially of, or consists of a partially reduced metal (IV) oxide active support of one or more of a ZrO₂, TiO₂, HfO₂, CeO₂, ThO₂ or MnO₂ containing one or more of a metal of a Pd, Pt, Ir, Cu, Ag or Au, wherein the catalyst is doped with one or more of a Group 1A alkali metal of Na, Li, K, Rb or Cs. It may therefore be appreciated that one can utilize mixtures of the identified partially reduced metal (IV) oxides as well as mixtures of the indicated metals or mixtures of the identified Group 1A alkali metals.

The metal selected from one or more of a Pd, Pt, Ir, Cu, Ag or Au is preferably present at a level of 0.5% (wt.) to 10.0% (wt.), more preferably 0.5% (wt.) to 5.0% (wt.). Such metals are preferred as they provide relatively low hydrogenation activity and are therefore relatively less prone to CH₄ formation. The Group 1A alkali metal selected from one or more of a Na, Li, K, Rb or Cs is preferably present at a level of 0.1% (wt.) to 10.0% (wt.), more preferably 0.1% (wt.) to 5.0% (wt.), or even more preferably 1.5 wt. % to 4.0 wt. %. In one particularly preferred embodiment, a partially reduced zirconium (IV) oxide active support contains Pt at a level of 0.1% (wt.) to 5.0% (wt.) and is doped with Na at a level of 0.1 wt. % to 5.0 wt. %.

By active support it is understood that the metal (IV) dioxide that is partially reduced is itself now participating in the RWGS catalytic cycle that forms reactive intermediates that ultimately result in the formation of CO. The preferred temperature range for use of RWGS catalyst herein is between 200° C. to 500° C., more preferably 200° C. to 450° C. or even 200° C. to 400° C., including all values and increments therein. The preferred pressure range is 1 bar to 40 bar, including all values and increments therein. More preferably, the pressure range is 1 bar to 20 bar, including all values and increments therein.

The selectivity of the RWGS catalyst herein is such that as alluded to above, the carbon dioxide present preferably follows Equation (1) over Equation (2). In particular, over the above referenced and preferred temperature range between 200° C. to 500° C. and preferred pressure range of 1 bar to 40 bar, ≥96.0%, or ≥97.0%, or ≥98.0% or even >99.0% of the introduced carbon dioxide is converted to carbon monoxide. In other words, the catalyst composition herein allowed for selectivity control by increasing the relative rate of reaction 1 (Equation 1) leading to carbon monoxide formation (R_{CO}) relative to the rate of reaction 2 (Equation 2) leading to methane formation (R_{CH4}). Accordingly, the catalyst system herein provides that R_{CO}>R_{CH4}.

The reverse water gas shift catalyst herein is prepared by adding, by way of one preferred example, a platinum precursor (e.g., tetraamine platinum (II) nitrate) to a zirconium (IV) dioxide powder (e.g., monoclinic ZrO₂ pellets sieved to 63 to 150 microns) using the incipient wetness impregnation method or other wet impregnation technique. The catalyst was then calcined at 350° C. for 4 hours to decompose the Pt precursor to provide Pt oxide. After calcination, and again by way of example, an appropriate quantity of sodium nitrate salt was added to the surface using the incipient wetness impregnation method. The catalyst was further dried and then calcined at 350° C. in a muffle furnace for 4 hours to decompose the Na precursor. To activate the catalyst, it was reduced in hydrogen gas at 350° C. prior to operating it in the reactor. This procedure activates the Pt by producing metallic Pt nanoparticles, and it activates the zirconium dioxide and by promoting, during the RWGS, the formation of one or more of a carbonate group (⁻OC(O)O⁻), formate group (H—C(O)—O⁻) and/or bridging —OH groups, which groups are on the monoclinic ZrO₂ surface. Namely, surface carbonate, surface formate and bridging —OH groups are now preferably developed on the partially reduced zirconium(IV) dioxide at the resulting surface Zr⁺³ sites which Zr⁺³ sites are then located proximate to the Pt metal nanoparticles. Replacing O (formal charge of −2) from inert forms of zirconia with OH (formal charge of −1) in the active form leads to the conclusion that the formal charge of adjacent Zr atoms becomes +3.

Expanding on the above, the mechanism for the reverse water gas shift (RWGS) reaction may be understood to preferably involve: (1) CO₂ adsorption which is a process that may now be facilitated by the increased basicity provided by Na, producing adsorbed carbonate groups (—OC(O)O⁻); (2) conversion of the carbonate groups to formate (H—C(O)—O⁻); and (3) decarbonylation of the formate to CO and H₂O. As observed and reported herein, the Na attenuates the methanation side reaction (Equation 2). This methanation side reaction is also typically understood to involve multiple metal sites and is considered to be a structurally-sensitive reaction (a reaction in which the kinetics are a function of ensemble size, which is the number of surface atoms required to constitute an active site for a particular reaction). Therefore, should one be able to block, inhibit or break-up of ensembles of Pt, such would preferably diminish methanation selectivity.

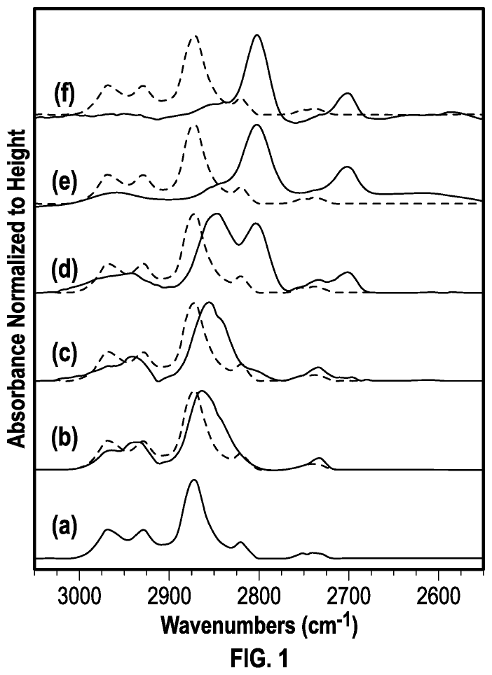

A weakening of the formate C—H bond by the use of Na herein (thereby promoting the formation of CO and H₂O) is now demonstrated in FIG. 1. Namely, FIG. 1 shows absorbance normalized to height versus wavenumbers for the RWGS reaction herein at 250° C. employing a 2.0% Pt/ZrO₂ catalyst where the n(CH) band of the observed formate groups (H—C(O)—O⁻) move to relatively lower wavenumbers as the level of sodium is increased, which confirms a weakening of the formate C—H bond. Namely, absorbance spectrum (a) is 2.0% Pt/ZrO₂; spectrum (b) is 0.5% Na-2.0% Pt/ZrO₂; spectrum (c) is 1.0% Na-2.0% Pt/ZrO₂; spectrum (d) is 1.8% Na-2.0% Pt/ZrO₂; spectrum (e) is 2.5% Na-2.0% Pt/ZrO₂; and spectrum (f) is 5.0% Na-2.0% Pt/ZrO₂. The dashed lines in FIG. 1 denote the 2.0% Pt/ZrO₂ reference spectrum. Reference to the percent of Pt and Na herein is percent by weight (wt.).

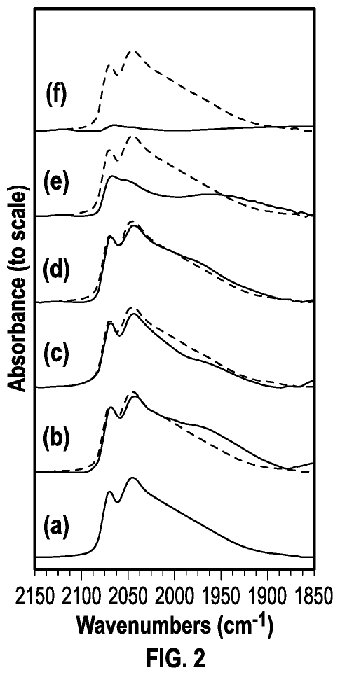

FIG. 2 next shows that the Pt-carbonyl n(CO) bands for the CO absorbed on the Pt move to lower intensities with increasing Na content. Namely, FIG. 2 shows absorbance (to scale) versus wavenumbers for the RWGS reaction herein at 250° C. Again, absorbance spectrum (a) is 2.0% Pt/ZrO₂; spectrum (b) is 0.5% Na-2.0% Pt/ZrO₂; spectrum (c) is 1.0% Na-2.0% Pt/ZrO₂; spectrum (d) is 1.8% Na-2.0% Pt/ZrO₂; spectrum (e) is 2.5% Na-2.0% Pt/ZrO₂; and spectrum (f) is 5.0% Na-2.0% Pt/ZrO₂. The dashed lines in FIG. 2 identify the 2.0% Pt/ZrO₂ reference spectrum. Reference to the percent of Pt and Na is again percent by weight (wt.). FIG. 2 therefore shows that Na has an interaction with the Pt sites, as increasing Na dopant levels tend to alter the distribution of the platinum carbonyl bands and suppress Pt metal sites at higher loadings (i.e. 58% of the site capacity at 2.5% Na and just 7.0% of the site capacity at 5.0% Na). This therefore suggests that the addition of Na herein may block, inhibit or break-up ensembles of Pt to preferably diminish methanation selectivity (Equation 2).

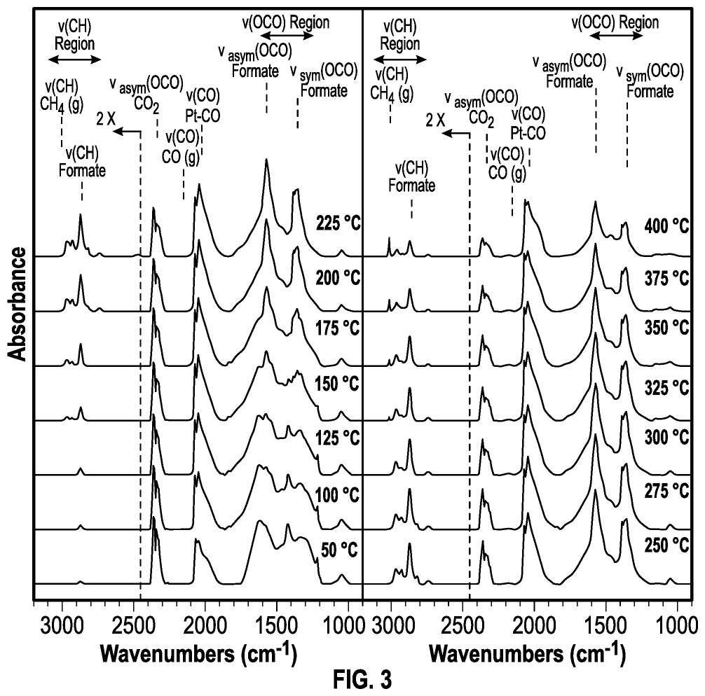

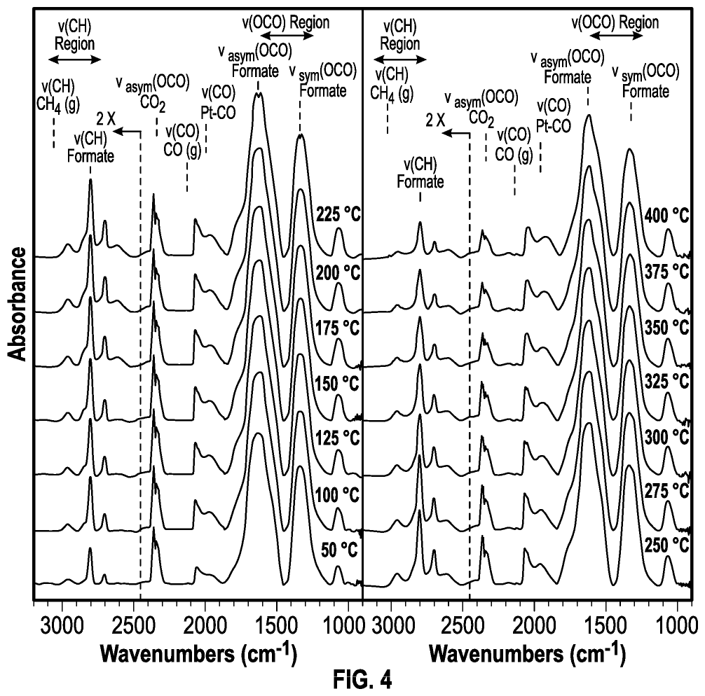

In addition, a relative acceleration of formate (H—C(O)—O⁻) formation during the RWGS herein using a 2.0% m-Pt/ZrO₂ catalyst (control) and a sodium-doped catalyst (2.5% Na-2.0% Pt/ZrO₂) was observed. Reference to the percent of Pt and Na herein is again percent by weight (wt.). Namely, diffuse reflectance infrared Fourier transform spectroscopy (DRIFTS) was employed using a Nicolet iS-10 and a Harrick praying mantis cell. Each sample was reduced in a 1:1 H₂/He mixture at 300° C. for 1 h at 200 ml/min and spectra were recorded (512 scans, scan resolution 4 cm⁻¹) during reduction. Following cooling to 50° C. in flowing He at 100 ml/min, another scan was taken. Then, a mixture containing 4% CO and 60% H₂ (balance He) was flowed at 100 mL/min through the reaction chamber at 50° C., and a spectrum was recorded. The temperature was sequentially increased to 100° C., 125° C., 150° C., 175° C., 200° C., 225° C., 250° C., 275° C., 300° C., 325° C., 350° C., 375° C. and 400° C. and scans were recorded. FIG. 3 shows the absorbance versus wavenumbers for the 2.0% Pt/ZrO₂ control at the indicated temperatures and FIG. 4 shows the absorbance versus wavenumbers for the 2.5% Na-2.0% Pt/ZrO₂ catalyst. Reference to the percent of Pt and Na is again percent by weight (wt.).

Acceleration of formate formation through Na addition and promotion of the RWGS reaction herein (Equation 1) can therefore now be observed by comparison of FIGS. 3 and 4. In FIG. 3, the v(CH) band of formate for the 2.0% Pt/ZrO₂ control is relatively weak at 50° C. and remains so until about 200° C. By comparison, in FIG. 4, the v(CH) band of formate is already relatively intense at 50° C. for the 2.5% Na-2.0% Pt/ZrO₂ catalyst, and higher than that of the 2.0% Pt/ZrO₂ control.

The inhibition of methanation (Equation 2) was also confirmed by comparing the temperature at which the v(CH) signal of gas phase methane (CH₄), occurring in the range of 3010 cm⁻¹ to 3020 cm⁻¹, was observed. This signal is detected at about 275° C. for the 2.0% Pt/ZrO₂ control catalyst (FIG. 3) whereas it is initially detected at about 325° C. for the 2.5% Na-2.0% Pt/ZrO₂ catalyst (FIG. 4). This higher temperature confirms that the Na present is inhibiting the methanation rate (Equation 2).

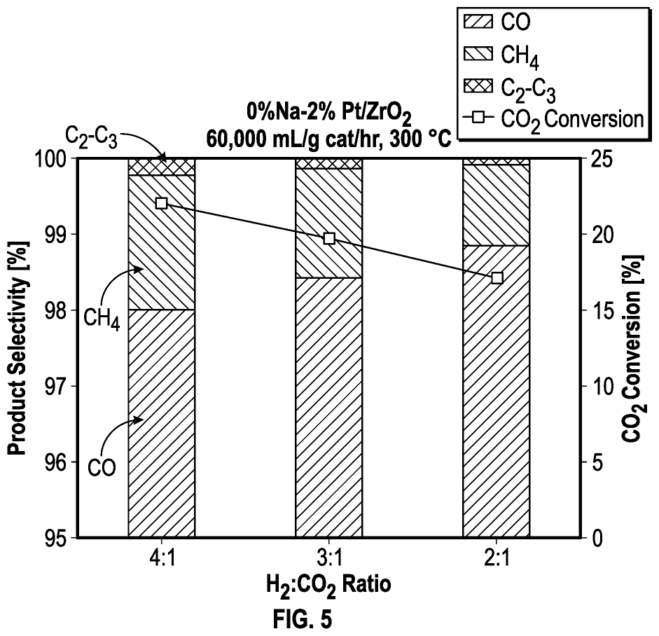

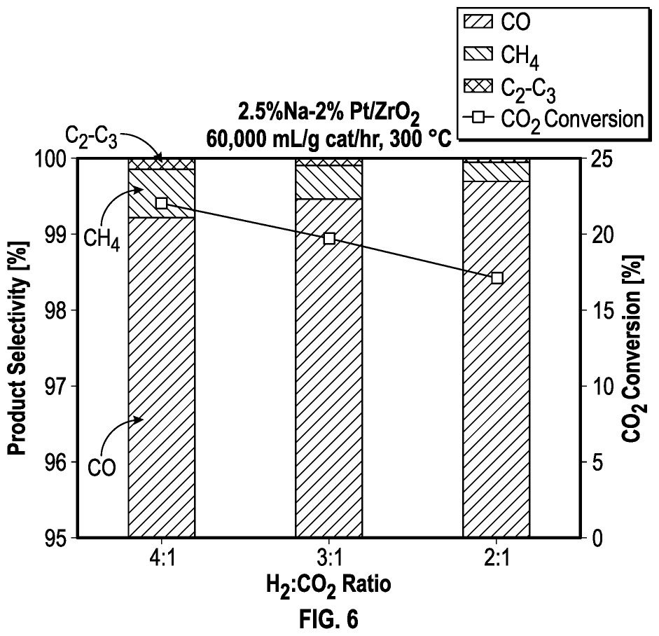

The catalysts themselves were then next evaluated in a series of reactor experiments to demonstrate their performance. In the reactor experiments summarized in FIGS. 5-6, the H₂:CO₂ ratio was varied between 4:1 to 2:1 to observe its impact on CO₂ hydrogenation trends for the undoped 2.0% Pt/ZrO2 catalyst (FIG. 5) and 2.5% Na-2.0% Pt/ZrO₂ catalyst (FIG. 6) in a fixed bed reactor. Reference to the percent of Pt and Na is again percent by weight (wt.). All gases were measured in real time using FTIR to detect CO₂, CO, water, methane, and C₂-C₃ species (ethane, ethylene, propane, and propylene). As can be seen in FIGS. 5 and 6, CO₂ conversion to CO decreased with increasing H₂:CO₂ ratio while product selectivity % towards methanation increased. At all tested H₂:CO₂ ratios, methane and C₂-C₃ selectivity decreased by up to 76% and 74% respectively for the Na doped catalyst (2.5% Na-2% Pt/ZrO₂).

It is noted that the difference in the methane selectivity noted above between the Na doped and undoped Pt/ZrO₂ was relatively more pronounced at lower reactor space velocity and increased pressure. As pressure is increased in the reactor, and without being bound by the following, it appears that reactions that produce relatively fewer gas molecules, such as methanation, are thermodynamically favored over reactions such as the reverse water gas shift that yield no overall change in gas molecules present in the system.

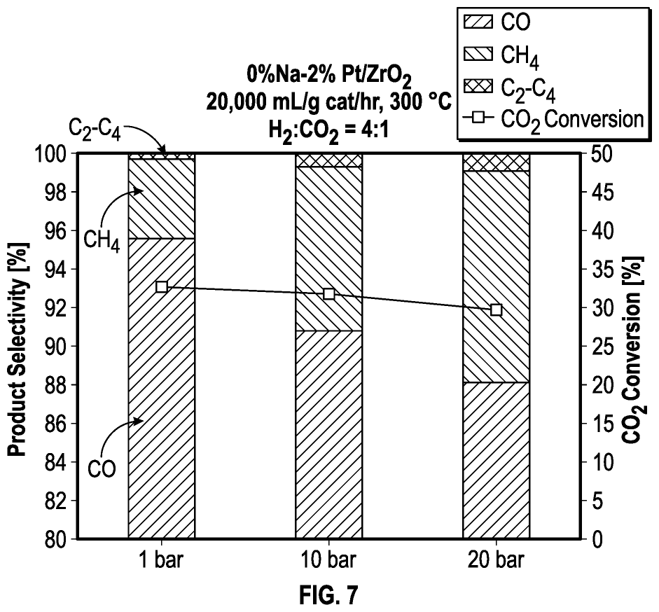

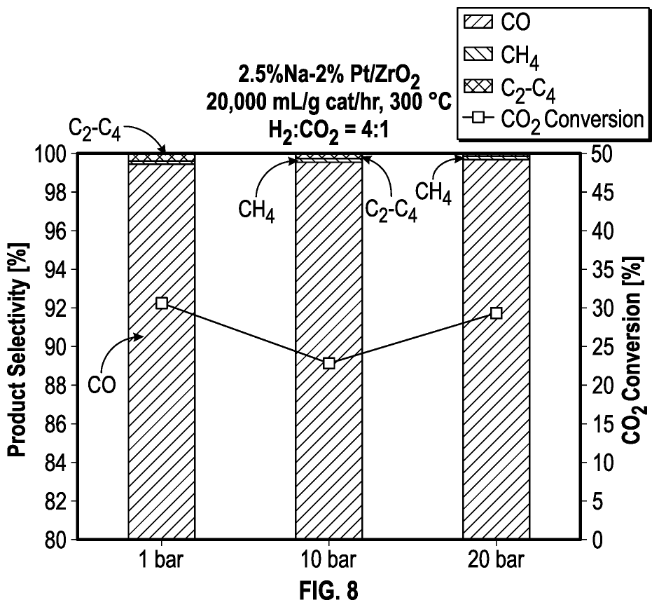

FIGS. 7 and 8 show CO₂ conversion (no. moles of CO₂ reactant converted divided by the no. of moles of CO₂ fed into the reactor) and product selectivity (number of moles of carbon in each of the products formed (i.e., CO, CH₄ or C₂-C₄) divided by the number of moles of CO₂ converted) in the reverse water gas shift reaction, 20% CO₂ and 80% H₂, for an undoped 2.0% Pt/ZrO₂ catalyst (FIG. 7) and 2.5% Na-2.0% Pt/ZrO₂(FIG. 8), now at variable pressure. Reference to the percent of Pt and Na is again percent by weight (wt.). As shown in FIG. 7, the 2.0% Pt/ZrO₂ catalyst selectivity to methane increased from about 4.0% to about 12.0% when the reactor pressure was increased from 1 bar to 20 bar. On the other hand, as shown in FIG. 8, the 2.5% Na-2.0% Pt/ZrO₂ catalyst indicated a methane selectivity of less than 0.2% from 1 to 20 bar. It is noted that the outlet gas concentrations were measured using gas chromatography of bag samples collected over the course of the reactor experiment.

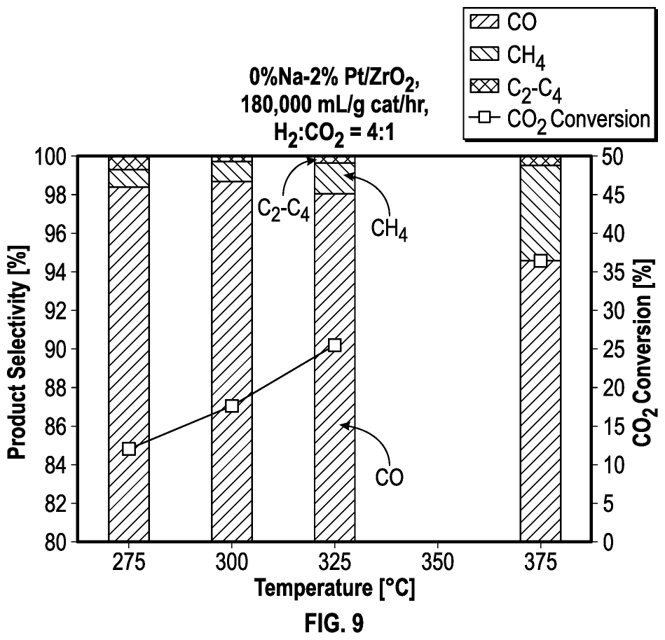

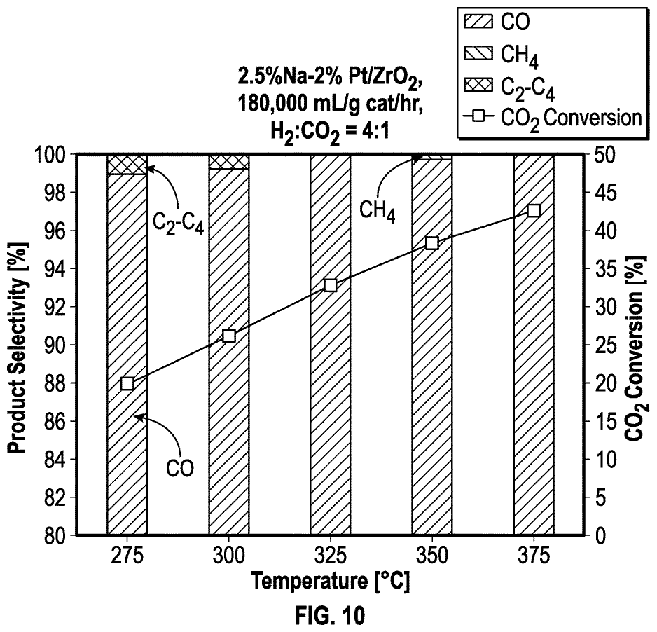

Next, the Na doped and undoped Pt/ZrO₂ catalysts were tested at various temperatures. FIG. 9 shows the effect of temperature on CO₂ conversion and product selectivity under the reverse water gas shift conditions, 20% CO₂ and 80% H₂ at 1 bar for the undoped 2.0% Pt/ZrO₂ catalyst. FIG. 10 shows the effect of temperature on CO₂ conversion and product selectivity under the reverse water gas shift conditions, 20% CO₂ and 80% H₂ at 1 bar for the 2.5% Na-2.0% Pt/ZrO₂ catalyst. Reference to the percent of Pt and Na is again percent by weight (wt.). As can be observed, the selectivity of the undoped 2.0% Pt/ZrO₂ catalyst for methane was higher at each temperature that was tested, ranging from 1.0% to 5.0% whereas for the 2.5% Na-2.0% Pt/ZrO₂ catalyst the methane selectivity remained below 1.0%.

What is claimed is:

1. A catalyst for performing a reverse water gas shift (RWGS) reaction comprising a partially reduced metal (IV) oxide active support of one or more of a ZrO₂, TiO₂, HfO₂, CeO₂, ThO₂ or MnO₂ that contains a metal of one or more of a Pd, Pt, Ir, Cu, Ag or Au, wherein the catalyst is doped with a Group 1A alkali metal of one or more of a Na, Li, K, Rb or Cs.

2. The catalyst of claim 1 wherein said partially reduced metal (IV) oxide active support of one or more of a ZrO₂, TiO₂, HfO₂, CeO₂, ThO₂ or MnO₂ contains said metal of one or more of a Pd, Pt, Ir, Cu, Ag or Au at a level of 0.5 wt. % to 10.0 wt. %.

3. The catalyst of claim 1 wherein said partially reduced metal (IV) oxide active support of one or more of a ZrO₂, TiO₂, HfO₂, CeO₂, ThO₂ or MnO₂ contains said metal of one or more of a Pd, Pt, Ir, Cu, Ag or Au at a level of 0.5 wt. % to 5.0 wt. %.

4. The catalyst of claim 1 wherein said partially reduced metal (IV) oxide active support comprises ZrO₂ and contains Pt.

5. The catalyst of claim 4 wherein said Pt is present at a level of 0.5% (wt.) to 5.0% (wt.).

6. The catalyst of claim 1 wherein the Group 1A alkali metal is present in said catalyst at a level of 0.1% (wt.) to 10.0% (wt.).

7. The catalyst of claim 1 wherein the Group 1A alkali metal is present in said catalyst at a level of 0.1% (wt.) to 10.0% (wt.)

8. The catalyst of claim 1 wherein said Group 1A alkali metal comprises Na and is present in said catalyst at a level of 0.1% (wt.) to 5.0% (wt.).

9. The catalyst of claim 5 wherein said Group 1A alkali metal comprises Na and is present in said catalyst at a level of 0.1% (wt.) to 5.0% (wt.).

10. The catalyst of claim 1 wherein said partially reduced metal (IV) dioxide active support comprises a partially reduced ZrO₂.

11. The catalyst of claim 10 wherein said partially reduced ZrO₂ has a surface that contains surface Zr⁺³ sites and/or surface —OH groups.

12. A method for catalyzing a reverse water gas shift reaction comprising:
a. providing a catalyst comprising a partially reduced metal (IV) oxide active support of one or more of a ZrO₂, TiO₂, HfO₂, CeO₂, ThO₂ or MnO₂ that contains a metal of one or more of a Pd, Pt, Ir, Cu, Ag or Au, wherein the catalyst is doped with a Group 1A alkali metal of one or more of a Na, Li, K, Rb or Cs;
b. supplying the catalyst with a flow of carbon dioxide and hydrogen gas;
c. heating the catalyst to a temperature in the range of 200° C. to 500° C. and a pressure of 1 bar to 40 bar; and
d. recovering carbon monoxide.

13. The method of claim 12 wherein greater than or equal to 96.0% of the supplied carbon dioxide is converted to carbon monoxide.

14. The method of claim 12 comprising heating to a temperature in the range of 200° C. to 400° C. and a pressure of 1 bar to 20 bar wherein greater than or equal to 96% of the carbon dioxide is converted to carbon monoxide.

15. The method of claim 12 wherein said partially reduced metal (IV) oxide active support of one or more of a ZrO₂, TiO₂, HfO₂, CeO₂, ThO₂ or MnO₂ contains said metal of one or more of a Pd, Pt, Ir, Cu, Ag or Au at a level of 0.5 wt. % to 10.0 wt. %.

16. The method of claim 12 wherein said partially reduced metal (IV) oxide active support of one or more of a ZrO₂, TiO₂, HfO₂, CeO₂, ThO₂ or MnO₂ contains said metal of one or more of a Pd, Pt, Ir, Cu, Ag or Au at a level of 0.5 wt. % to 5.0 wt. %.

17. The method of claim 12 wherein said partially reduced metal (IV) oxide active support comprises ZrO₂ and contains Pt.

18. The method of claim 17 wherein said Pt is present at a level of 0.5% (wt.) to 5.0% (wt.).

19. The method of claim 12 wherein the Group 1A alkali metal of one or more of a Na, Li, K, Rb or Cs is present in said catalyst at a level of 0.1% (wt.) to 10.0% (wt.).

20. The method of claim 12 wherein the Group 1A alkali metal of one or more of a Na, Li, K, Rb or Cs is present in said catalyst at a level of 0.1% (wt.) to 5.0% (wt.).

21. The method of claim 12 wherein the Group 1A alkali metal comprises Na and is present in said catalyst at a level of 0.1% (wt.) to 5.0% (wt.).

22. The method of claim 18 wherein the Group 1A alkali metal comprises Na and is present in said catalyst at a level of 0.1% (wt.) to 5.0% (wt.).

23. The method of claim 17 wherein said ZrO₂ has a surface that contains surface Zr⁺³ sites and/or surface —OH groups.

24. A method for catalyzing a reverse water gas shift reaction comprising:
a. providing a catalyst comprising a partially reduced zirconium (IV) oxide active support that contains Pt at a level of 0.5 wt. % to 10.0 wt. % wherein the catalyst is doped with Na at a level of 0.1 wt. % to 10.0 wt. %;
b. supplying the catalyst with a flow of carbon dioxide and hydrogen gas;
c. heating the catalyst to a temperature in the range of 200° C. to 500° C. and a pressure of 1 bar to 40 bar; and
d. recovering carbon monoxide wherein greater than or equal to 96.0% of the carbon dioxide is converted to carbon monoxide.

25. The method of claim 24 wherein said partially reduced zirconium (IV) oxide active support has a surface that contains surface Zr⁺³ sites and/or —OH groups.

26. The method of claim 25 wherein greater than or equal to 96.0% of the supplied carbon dioxide is converted to carbon monoxide.
